(19) United States
(12) Patent Application Publication
(10) Pub. No.: US 2018/0165363 A1
(43) Pub. Date: Jun. 14, 2018

(54) MULTI SEARCH AUTOMATED BLAST SEARCH ENGINE WITH UNIVERSAL EMBEDDABLE FUNCTIONS

(71) Applicant: Lawrence F Glaser, Fairfax Station, VA (US)

(72) Inventor: Lawrence F Glaser, Fairfax Station, VA (US)

(21) Appl. No.: 15/575,457

(22) PCT Filed: May 18, 2016
(86) PCT No.: PCT/US16/32964

§ 371 Date: Nov. 20, 2017

Related U.S. Application Data
(60) Provisional application No. 62/162,872, filed on May 18, 2015.

(51) Int. Cl. G06F 17/30

(52) U.S. Cl. CPC G06F 17/30864; G06F 17/246

(57) ABSTRACT

A search engine function which works serially as in the prior art, except where the user loads search criteria after receiving an automatically administrated parallel multi-search result. Each parallel function allows options pre-set by the user, for a single “one click” loading of search terms. Thus the user sees a spread of results far more meaningful than a single column, using space across the display as well as down in columnar formats, optionally tiled as well, which may include automatic tiling, texturing, aural tags and color coding. A single search under the old systems provides a column, possibly with pages of single columns. This search provides tens or hundreds of variations apart from the single search, displaying the results with the one effort and providing formatting and colorizing (or texturizing, and aural marking) features to alert the user to a specific kind of hit.

### BACKGROUND

Search engine philosophy limits the result to columnar arranged linear results based on accessible data wherein the order of hits and type of hits is in part, dictated by the owner of the data being willing to pay for the right to appear higher in the search result, due to the serial and linear nature of search engines and search engine results. As an example, one pays to dominate a particular stacked result. Hence information available where the source is not paying a higher fee to appear higher in the hit order, may be missed entirely.

The party conducting the search has to then think of creative means to search and get hits and hit order which brings the data they wish to find closer to the top of the stack, so they do not need to review the whole stack plus additional pages to find their data, such as the 334th hit in a stack, page 22.

U.S. Pat. No. 8,543,936, for example, teaches a search engine which provides some user flexibility, yet which lacks pattern and combinations involving patterns, or the ability of subscribers being able to pay a smaller fee, yet hit high on a user's search criteria.

U.S. Pat. No. 8,688,673 and U.S. Pat. No. 7,873,657, for example, provides iterated modifiable searching but without user flexibility to alter search modification settings easily, or embedded multi-dimensional results.

### SUMMARY

The present invention solves the problems of the prior art by, inter alia, embedding enhanced search functions into the heart of other operable programs, such as text drafting (Microsoft WORD) or spreadsheet (Microsoft XL) In conclusion, the inventor sees a need to improve hits and hit significance as well as order in a single search effort, to better serve the user community. Further, the enhanced capabilities of this new search engine form can be leveraged by other operable programs, yielding new and creative possibilities for legacy type programs, such as word processing and spreadsheets. It is noted, programs now operate on smaller more mobile devices and even virtually, in a cloud-computing scheme. To aid users who have impediments, it may be preferable for the entirety of the invention to be adapted to allowing voice commands to program and arrange the search functions, accordingly.

Proposed herein is the concept of providing a search engine function which works serially as in the prior art, except where the user loads in their search criteria once they receive an automatically administrated parallel multi-search result. Each parallel function has different options which may be pre-set by the user, so the loading in of the search term or terms is done once, and the search is commenced with “one click”. Due to the power and advanced ordering features of this search engine, the user sees a spread of results far more meaningful than a single column, using space across the display as well as down in columnar formats, optionally tiled as well, which, in embodiments, includes automatic tiling, texturing, aural tags and color coding. A single search under prior art systems provides a column, possibly with pages of single columns. The search according to the present invention provides potentially tens or hundreds of variations apart from the single search, displaying the results with the one effort and providing formatting and colorizing (or texturizing, and aural marking) features to alert the user to a specific kind of hit.

In embodiments, the search input field and results field are embedded into other programs, such as word processing and spreadsheets. This dynamic offers exponential power for users to take advantage of all the functions of this search engine, its full and complete use and programming, in embodiments is adapted to allow voice to text to manage the invention. Further, users who are familiar with voice to text interfaces could develop macros to speed programming or just input and use of the search engine.

The present invention provides pattern search and combinations involving pattern such as search for pattern 1 and pattern 2, or search for pattern 1+TEXT. It also allows subscribers or network present entities to pay a smaller fee, yet hit high on a user's search criteria. An example is where a party has expertise in a very specific area and yet, they are 10,000 miles away. Normally, a single practicing entity with a uniquely honed set of skills could be difficult to locate as they may not have the money to list themselves in every geography so a search can find them. With this invention, the means are provided to narrow to, say, one result when a poorly-limited search query may yield hits in the millions. Particular logical functions are able to improve query phrasing. The present invention solves this problem by providing a search engine that may be pointed at separate data bases, where additional pre-set search criteria will invoke the separate data base.

For purpose of this invention the search is not limited to characters or character strings, type face, color of type, size of type or any other attributes, such as language. Also included is pattern search and combinations of pattern and image search which may optionally be associated with text, so, in embodiments, one searches using a very powerful set of tools to find relevant information. In a further embodiment, a video is loaded as a search criteria, to find where other instances of the same video or portions of the same video preside. In yet another embodiment, water marks present in the video (or in an image), representing unique identifying data, are searched independently to yield a hit and pathway to the video. The concept of search for pattern or watermark crosses over into allowing search for presence of an associated (relational data) biometric or multi-biometric in a data base, accessible through a network.

### DESCRIPTION OF FIGURES

FIG. 1 shows the first page of the search engine concept of the present invention.

FIG. 2 is a simplified view of the graphic user interface of the present invention.

FIG. 3 shows elements 300, a search term, 301, a search term auto-populated by the input of a term in 300. These results are shown embedded in programs such as MSWord.

FIG. 4 shows auto-population, inspection and search modification.

FIG. 5 depicts modification of the inputs to the search engine and their use of Networks, Data bases and connectivity pathways.

### DETAILED DESCRIPTION OF THE INVENTION

In search engines according to the prior art, the user inputs a search term and hits enter. No matter what string is sent or how much filtering and other logic is deployed, the result is a column. It is almost impossible for that column to be one page. It's usually 10 or more pages. There is also considerable latency in culling through the hits and there is usually no second search function to search only within what was obtained the first time, eg cull only the hits, rather than starting a new search.

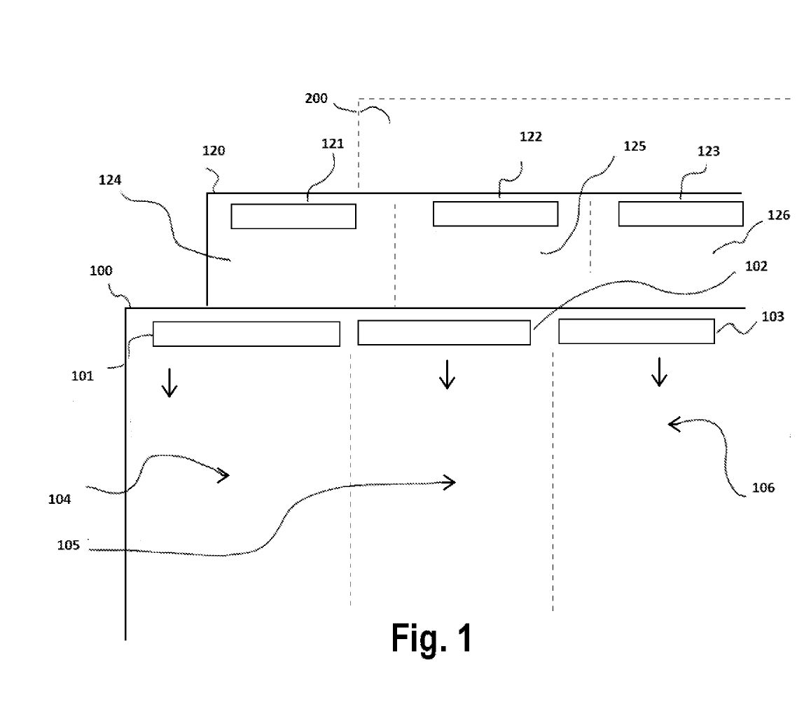

FIG. 1 shows elements 100 is the first page of the search engine concept which is linked to all pages in the software, 101 is a first search criteria box or field which may be populated with a character, image, pattern or combinations of these placed in order from left to right within the field, 102 is a second search criteria box or field which may be populated with a character, image, pattern or combinations of these placed in order from left to right within the field, 103 is a third search criteria box or field which may be populated with a character, image, pattern or combinations of these placed in order from left to right within the field, 104 is a larger field where results of the search effort may be stacked as hits with a weighted order representing the results for field 101, 105 is a larger field where results of the search effort may be stacked as hits with a weighted order representing the results for field 102, 106 is a larger field where results of the search effort may be stacked as hits with a weighted order representing the results for field 103 and 120 is the second page of the search engine concept linked to the first and also to any subsequent pages which may only be limited by memory or software limits. 121 is a field which can be used as a filter and linked to field 101 of page 100 for automatic filtration and stacked results post filtration, 122 is a field which can be used as a filter and linked to field 102 of page 100 for automatic filtration and stacked results post filtration, 123 is a field which can be used as a filter and linked to field 103 of page 100 for automatic filtration and stacked results post filtration, 124 is the filtered stacked results for field 121, 125 is the filtered stacked results for field 122, 126 is the filtered stacked results for field 123 and 200 is considered the last page and is significant in that the final “most boiled down” search results will appear here. Nothing contained herein is intended to limit the user from having the pages appear in any order they wish or to hide pages as they wish, including locking the pages or the fields (which may display a greyed out pattern and require different pass codes to unlock, either universal across the board or, per field or per page or combinations of same) so they cannot be viewed by other users so as to protect the user's creative use of key words, operands and filters.

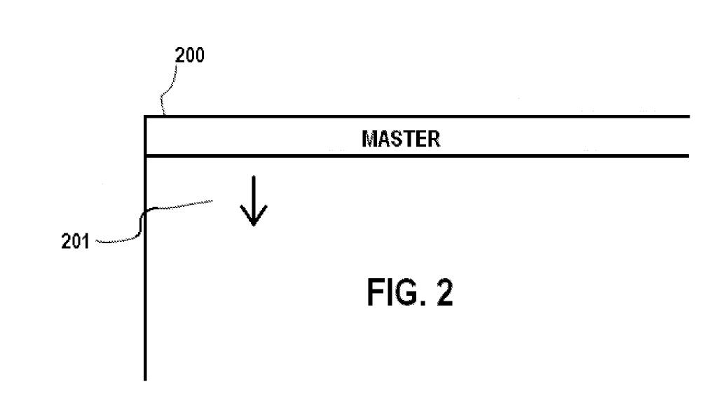

FIG. 2 is a simplified view of the last page 200 of the graphic user interface which will show results columnar in field 201.

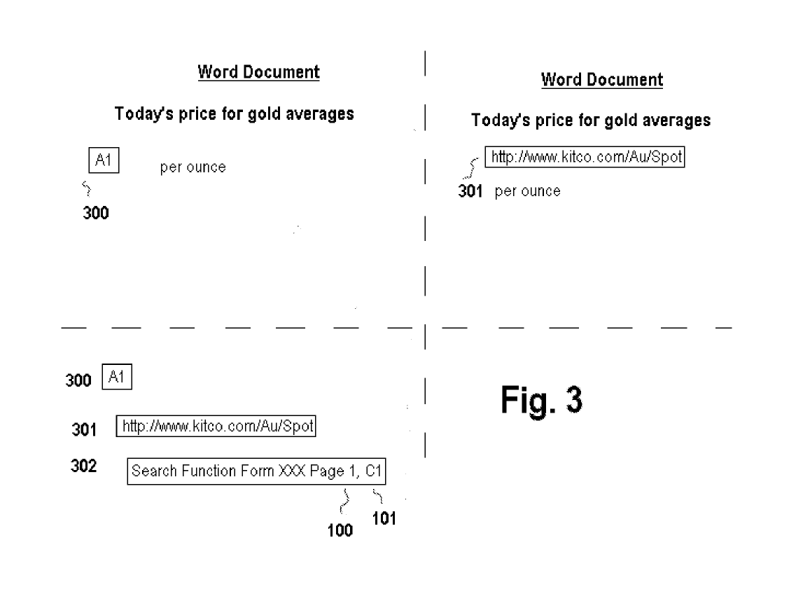

FIG. 3 shows elements 300, a search term, 301, a search term auto-populated by the input of a term in 300. These results are shown embedded in programs such as WORD (Word processing). 302 is a tracing function allowing for the user to know where the results seen in documents originate from, without having to leave the document or start a different program.

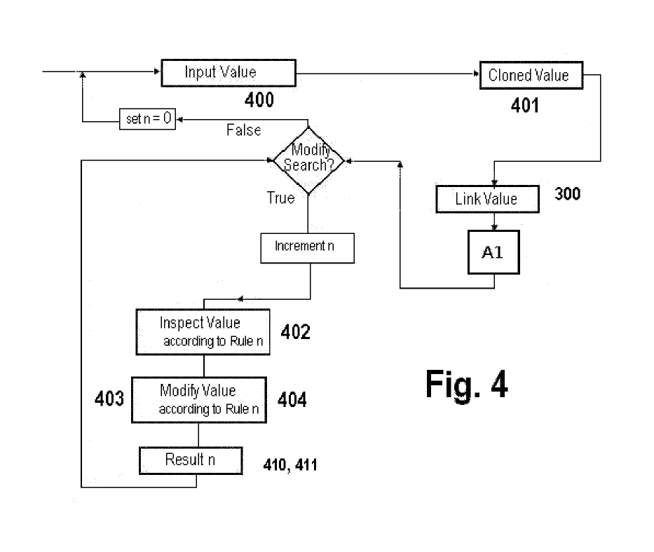

FIG. 4 shows relationships between elements of the invention 400, 401, 402, 403, 404 and 410. In this example, input search term 400 causes an auto-population without any extra effect to 401. Another primary input 400 is shown connected to an inspection stage 402 where the input is automatically inspected to determine color, shape, polarity, even, odd, typeface, typestyle, artificial intelligence logic (with result), Boolean logic (with result) or any other inspection which a computer automatically performs. 403 and 404 are example conditionally applied rules 1 & 2, respectively, to further modify a search term and execute a search to generate a result or a failure to generate a result (a result of null). Because a value can be a long string, I provide a simple linking tool to link a long value to an abbreviated value, in the given example 401 is linked to 300 and 300 is an abbreviated value. Not shown are tools to either manually or automatically colorize, auralize or texturize (or combinations of these) any and all elements in this invention which may be displayed or conveyed to the user.

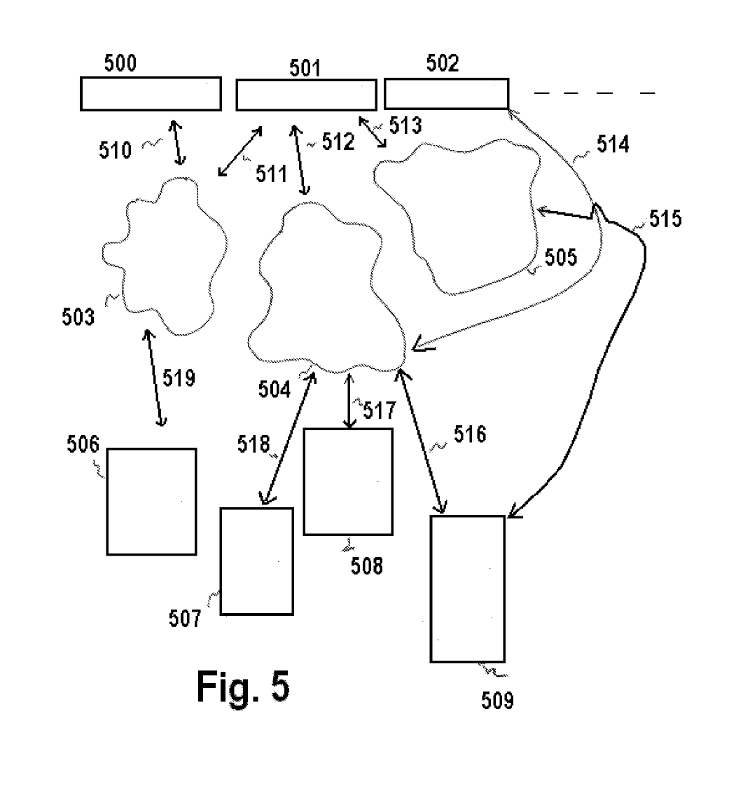

FIG. 5 depicts the inputs to the search engine of this invention starting with a primary input 500 which would automatically populate inputs 501, 502. Networks are represented as 503, 504 and 505. Data bases accessible by the networks are represented as 506, 507, 508 and 509. Potential connectivity pathways are shown as 510-519 and it is noted that these are not intended to be limiting. Any search term and its related pre-set programming can invoke any logical pathway plus the application of any and all logical operands or other forms of operands will apply to the result of the search.

The present invention offers the user a search field which is integrated to other search fields. Population of the first search field will automatically populate the other search fields according to settings available for each search field. Hence, in accordance with the invention, typing a brand name for a search such as Budweiser, causes normal search engine hits in the first column while a different column finds only imagery/art as it was set for this and yet another column finds only legal matters, again, due to the column being set this way in its settings. The user will then initiate search and the search will be conducted in parallel. In addition, a next stage of search can be pre-arranged and this second stage can automatically run when the first stage is initiated, providing different pages with different columns of results. So, in the above example, the different page could be the same search term and settings, but another page will display only results dated in a specific date range. In an embodiment, the next stage search in the form of a different page is followed by yet another page and in these pages, the criteria are user settable. To the user, this still manifests as a single step search not requiring extra effort on their part to see the results when they enter the search term and press “GO”. The first stage of the software operation is a multi parallel search, the second stage can include filtration and the results of logical operands boiling down the multiple search results to what the user anticipates will be most significant, based on settings. The settings are key to the concept as they will provide better results through the use of logical operands and other filtering or narrowing factors.

Not shown is mode shifting, which allows the user to view the formula that links each field to other fields, each page to other pages so as to form the connectivity needed to allow the user to input a single word, character, phrase, pattern or a complex string comprising characters, images and patterns so as to allow the final step, selecting “GO” or hitting <CR> and seeing the results instantly populate the various fields and final field 201 of the Master page 200. The search engine screen from which one launches a search can toggle between showing last search results or the programming found in each cell that caused the search results. In other words, the column, row, page view can show a search before, search result or the formulas used which will cause the search results.

Titles For Sale, Want To Sell, Repair of, extended warranty of, expert in, I am an expert in, lost, found, blogs for, manufacturer of, history of, inventions using, regulations pertaining to, value of, historic sales data, historic wear and tear, user ratings of, my ratings of, hash tag=, mem-tagged by user X, these are all examples of operands, functions which may be applied to a search criteria to mitigate the results. Examples of “mem-tagging” are disclosed in applicant's prior application US20150310060 is herein incorporated by reference for purposes of essential subject matter. Use a specific network, reach out through a network to a specific machine which in turn has access to yet another network, access a data base through a specific network, these are also threading functions to be included in functions that can be applied to a search term.

Operands (logical); AND, OR, NOT, combination logic such as NOTS (NOT-STRICT[interpretation]) versus NOT-W (NOT-WIDEST [fuzzy logic]) or a number such as limited to 1-10 following the command such as NOTS, setting the strictness of the NOT function to see if the hits vary sufficiently.

In an embodiment, unique users throughout the world, acting in their capacity as a single individual, build a data set about themselves which is used in the context of this search engine to find the individual. Each individual has their various capabilities, certifications, range of operation territorially speaking, and other factors similar to these, which the user can decide to make available to a search function and further, where the user can pay a premium to see their primary contact information and ID hit more frequently and appear higher in a list another user creates through a search conducted by a search engine or function. One way to achieve this is to include the data set in a data base with a name recognized by other users so they may deliberately name the data base and find the logical hits. By identifying a data base of users who are real people, identified and known, they can comprise a search effort and function which eliminates corporations, groups or organizations not representing a single individual, so as to find someone suitable to a task who is either in reasonable range, or available as needed to perform work or answer a question. There will soon be 10 billion people in the world. To interconnect them for purpose of work or social connection with better filters, search criteria and search engine capabilities without anyone having to pay an exorbitant amount, is a goal of this invention. In contrast, the review of a list 25000 hits long, will not find that one person in 10 billion without such a set of tools contemplated herein.

Having improved the search function using a new operable program which is believed to be novel and unique, I further suggest the use of potentially different search engines to perform search functions for each page, each column and each programmable field, each set by the user. Note that they are integrated, so the one step of loading in a search term causes all the other competing search engines to fire, and results to appear before the user in the manner described elsewhere in this invention.

To aid in latency issues for a very large and complex search, the user will be provided with tools to name browser instances which are virtual, perhaps held in a remote client or server which are “called” when set in the field, column or page for use. A default, such as for example “Chrome, on this machine (called by IP, Mac or any other unique identifier)” would be factory set. Options then allow the user to try different instances of the same search engine or different search engines, for example, when a particular search term and settings take a long time to provide results. The user can begin to explore using other search engines, even remote ones, to test if the net sum result is lower latency. The power of search under these criteria represents an exponential improvement in search results and hit relevance.

In embodiments, the user information is verified by biometric means, such as those disclosed in applicant's prior patent applications US20140074696 and US20140183269, which are incorporated herein by reference for purposes of essential subject matter.

In an embodiment, reports can be generated. The report can be sorted on user, date, time, search criteria and any other logical attribute or relational data of the use of the search engine of this invention. In an embodiment, a software tool is offered to allow the user, or a specified group of users to log into the software tool and pull up a report that resembles a spread sheet. The report allows the user or group to see their ownership of searches embedded into other programs. The report can be sorted on user, date, time, search criteria and any other logical attribute of the use of the search engine of this invention.

In an embodiment, the software tool used to show the user or a specified group of users their searches which they have created, also allows for turning on and off, an edit function so the user can edit a search or searches, which causes the change to permeate all documents the search was previously embedded within.

In an embodiment, a specific search result can be embedded in other programs, such as in a WORD, XL, or Powerpoint file. The tools necessary to dissect the individual search results to know from whence they came, and who created the search function are provided and made operable through the program in which the search result is embedded. Nothing shown or discussed is intended to be limiting, such that as many terms and search results as are necessary are anticipated, by the present invention, to be embedded within a program or programs (the files the user utilizes) and it may likewise be preferable for the search result to be updated, even when the programs (or the files) are closed

In an embodiment, the invention provides the user with the tools necessary to direct the initially inputted search term to one or more specific networks, and then, one or more specific data bases to generate the search result. The dynamics of this function allow for the creation of a data base and then a naming of the data base, connectivity to the data base through a network and then, advertising that this data base exists, such that users of this new search engine can know of the existence of the data base and cause a search result to be generated which would otherwise never find or know of the data base in question. Examples can include data bases of people with specific experience in specific areas and available either in person, or virtually, for specific needs. Finding a person educated and experienced in welding unusual metals, or repairing a very old engine for which few remember the quirks of the specific engine, are good examples of the data base creation, advertising and then linking to this search engine. Now the individual with the named experience can pay a very small fee and become known to billions of users.

In an embodiment, the whole of this invention is adapted to a speech to text software function to allow greater ease of use for all users.

From a reading of the totality of this new search engine invention, the reader can now understand what happens when search is improved in terms of providing the user with a way to type minimally, hit go and get maximal results. Embedding these functions into other programs where the mere opening of the file causes the search function to fire and populate a result field, adds to the dynamics of this invention. Imagine if a word document contained one hundred or one thousand such searches? It is further noted the tools to allow one user to manage searches which have been saved and cloned into other programs operating on other machines either across a local network or any other, such as the WWW, further expands the power of this invention series. The reporting features will be very powerful, capable of tracking the popular search algorithms to whatever end these searches find use, in any machine, across any network or cloud resident. Thereafter, the concept improves exponentially the function of certain popular program families such as word processing, slide show, web page development and spreadsheet. Further, that there is a better way to organize search fields to allow for hit ordering based on who pays to achieve a higher hit status, but under a specific field name, the example given was sole practitioners in an art form such as painting, carpentry, but the concept need not limit to that field-listing relationship, Other examples include such relationships as private antique dealer, accredited experts, excess materials available for free, dirt exchange for fill or removal during construction, public-civic duty opportunities such as group road cleaning seeking volunteers with local sponsors providing some enumeration or just for publicity.

In an embodiment, the search field or search result field, embedded within another program, such as a cell on an XL spreadsheet, provides a colorized, textured, aural or other indication that the search function is down and provide further diagnostic information such as the main network to the machine in question is down, or the cloud is experiencing a malfunction. In such case, the cell with the search criteria or search result is programmed to have a default value for each such cell embedded in another program and an indication that the viewer is viewing a default value, not a search criteria or result.

In an embodiment, the search function as a whole, is reversed, and the search field can be programmed to operate as a “reverse search”. This means the user is inputting an optimal result and executing a search to which the engine provides optimal or function guided results which are search terms. This reverse search is precisely the opposite of a search in every manner. It is useful if a user has tried searching on a term and is suspicious that there may be a better way to search the term, hence the use of reverse logic dictates the user could try this reverse search for similar search result terms to find optimal search key phrases or wording resulting in better search results.

New input of a search term even as short as “a” populates a form (a new form factor) to be used as an output. The user has not hit “go” yet. What the user sees at present is, in one embodiment, comparable to a spreadsheet. For use in a manner which is familiar, the letter “a” my input, is found in the top cell of every column on Page 1, 2, 3, 4 etc. . . . and they are all tiled, the user having previously set the logic and other operations of each column and page. The user may also arrange logic from any cell and to any cell, so, as an example, the logic is made to flow down aligned cells through pages to results page. Say page 100 is where the user looks for a search result. (the user still has not yet hit enter . . . ) If this tool is used in this manner, By inputting “a” into cell 1 of sheet 1, column 1, cell 1 on sheet 2, 3, 4, etc. . . . drill all the way through to page 100 and they relate to one another with automatic linking.

How the user may elect to use this capability falls into at least two areas. One is automatic features set by the manufacturer. The other are modifications the user may make prior to a search, for example by saving arrays of logic and functions under file names, so the user may conveniently pull up and use preset forms.

\In this example, the user is intending to hit ‘enter’ imminently and search for results for the character “a”. The user has programmed columns for every known language on earth, even sign. The cells running down the columns will show me variations of the letter in the language, if any, including capital, lower case, cursive capital, cursive lower case, short hand etc. The user, using the tools of the present invention, can go further and show every known type face in each language. In an extreme example in which the user wanted every sentence ever written in English that starts with a (space), the logic is present in the present invention to allow such a search, then put each sentence in the top cell of each column.

So by entering “a” and hitting enter, due to my programming and use of this tool, per the examples above, the top cell of each column is programmed with “a” and it searches.

Arguably, the present invention may be considered a parallel search because the engine in use, either resident on a user's machine or out in the cloud or server, can deploy all known prior art to make results come back faster.

What is invented herein is the ability to use a search term as an operand in a spread sheet, where the spread sheet no longer centers on math functions used between cells (although it could retain this ability), rather, the core focus and preferred embodiment allows you to put a search term into any cell and tell the program in fact the term is a search term. When the user hits an execute button which can be a carriage return at the right time, or clicking the right tool, the “complete array” executes. Not one search term. The search term is automatically copied when typed, into the other cells which are pre-set in the form.

In a further embodiment in accordance with the present invention, a given form which always provides a reliable result in a given cell which can be used creatively and logically to fill in missing data in an other wise fixed document is covered. So the price of spot gold in my word document saved as a file, SPOTGOLDTODAY.DOC is dynamically updated wherever my file goes.

For purposes of the present invention, the term LOGIC is not restricted to Boolean. So one could develop their own definition for AND as an example, the present invention has the power of a form that auto-populates and then uses new logic terms to perform searches.

The present invention, in embodiments, includes features such as turn off all columns which kills all columns and pages, leaving only a search field. The user puts in a search term or phrase and hits enter, giving a stack of results. The user can make thousands of search engines each with its own column. The user can make the term entered into the first autopopulate all the others. The term may be modified automatically so if the user were to make columns for other languages, the result is the translated term at the top. (hovering over it with mouse pointer, it will toggle to English while hovering over it, as English would be the base language). In order to make it to suddenly populate all that data in one click, the string data and even all the algorithms will be sent to the search engine in the cloud, so it can mimic the user's settings. In other words, cloud-mimicking the PC at home takes the search term typed (because the cloud can see each keystroke even though the user has not yet hit enter) and is already processing ahead. Hence the spirit of the present invention; no more single columns as in the prior art. Blast pages of info instead.

As the user types in the search term, letter for letter, the engine is already searching even before hitting go. That also applies to the formula(s) and algorithms, the whole structure of the engine. This search engine is no longer a single line . . . [put term here] If you put your term here [xxxxxxxx] it also automatically appears in tens, hundreds or even thousands of [xxxxxxyy] [XXXX] [XXYYZZ] and the term could be truncated or changed in some cases, based on the programming. Same applies to the expected result. Not just a column ranked “however” (by money others spend to skew search results)

The essence is to get a ranking based on merit, other people's reviews, for a doctor, lawyer, teacher, close enough to make sense to the user. The user cannot find them with the prior art, because someone has more money and pays to hit earlier. These good people are hit #332. The user will never find them. And this is but one programming . . . rank by independent ratings . . . .

Those experienced in the field of this invention should, based on the detailed descriptions of the objectives and new methods, be able to understand the logical possible variations. They will be able to adopt appropriate strategies depending on the various applications and needs of desktop computers, mobile devices and other platforms such as cloud computing scheme devices, not specifically shown in this application, but within the general goals and objectives of this invention.

Examples disclosed are intended to be limiting only as reflected in the appended claims.

1. A machine implemented method comprising the steps of:
providing an interface that is configured to design a custom search engine, said search engine comprising a search field within a program
displaying a result field in said program which is integrated to at least one other search field and wherein said at least one other search field further comprising at least one page having at least one column and wherein further said at least one column comprises at least one programmable field.

2. The machine implemented method of claim 1 further comprising steps of
consulting pre-set search criteria
invoking a pointer from said at least one other search field to a separate data base indicated by said pre-set search criteria.

3. The machine implemented method of claim 2 wherein at least one of said at least one other search field invokes a search engine selected to perform a specific search function for an element selected from the list of each page, each column or each programmable field.

4. The machine implemented method of claim 2 wherein said at least one other search field is comprised in another program.

5. The machine implemented method of claim 4 wherein said search field comprised in another program is a cell in a spreadsheet program.

6. The machine implemented method of claim 4 wherein said results field is automatically updated when said another program is opened.

7. The machine implemented method of claim 3 further comprising steps of:
causing an auto-population of a search term from said search field—duplicating said search term
connecting said search term to an inspection stage
automatically inspecting said duplicate search term to determine at least one quality selected from the list of color, shape, polarity, even, odd, typeface, typestyle, artificial intelligence logic (with result), Boolean logic (with result)
linking said duplicated search term to a field in said program or said another program.

8. The machine implemented method of claim 1 wherein at least one of the processor and the search engine reside on the cloud or on a server.

9. A computer storage medium having instructions, which when executed on a processor, cause the processor to: provide an interface that is configured to design a custom search engine, said search engine comprising a search field within a program and wherein the interface displays a result field in said program which is integrated to at least one other search field and further comprising at least one page having at least one column and a programmable field.

10. The computer storage medium of claim 9 which when executed on a processor further cause the processor to:
consult pre-set search criteria
invoke a pointer from said at least one other search field to a separate data base indicated by said pre-set search criteria.

11. The computer storage medium of claim 10 wherein at least one of said at least one other search field invokes
a search engine selected to perform a specific search function for an element selected from the list of each page, each column or each programmable field.

12. The computer storage medium of claim 10 wherein said at least one other search field is comprised in another program.

13. The computer storage medium of claim 12 wherein said search field is comprised in another program is a cell in a spreadsheet program.

14. The computer storage medium of claim 12 wherein said results field is automatically updated when said another program is opened.

15. The computer storage medium of claim 11 further comprising steps of:
causing an auto-population of a search term from said search field
duplicating said search term
connecting said search term to an inspection stage
automatically inspecting said duplicate search term to determine at least one quality selected from the list of color, shape, polarity, even, odd, typeface, typestyle, artificial intelligence logic (with result), Boolean logic (with result)
linking said duplicated search term to a field in said program or said another program.
